(19) United States
(12) Patent Application Publication
(10) Pub. No.: US 2016/0244577 A1
(43) Pub. Date: Aug. 25, 2016

(54) GRAPHENE POLYMER CONDUCTIVE FILM AND METHOD OF MANUFACTURING THE SAME

(71) Applicant: SHENZHEN CHINA STAR OPTOELECTRONICS TECHNOLOGY CO., LTD., Shenzhen, Guangdong (CN)

(72) Inventors: Xia ZHANG, Shenzhen, Guangdong (CN); Yungjui LEE, Shenzhen, Guangdong (CN); Yahui CHEN, Shenzhen, Guangdong (CN)

(73) Assignee: Shenzhen China Star Optoelectronics Technology Co., Ltd., Shenzhen, Guangdong (CN)

(21) Appl. No.: 14/430,208

(22) PCT Filed: Sep. 16, 2014
(86) PCT No.: PCT/CN2014/086589

§ 371 Date: Mar. 20, 2015

(30) Foreign Application Priority Data
Aug. 21, 2014 (CN) 201410415955.3

(51) Int. Cl. C08J 5/18; H01B 1/24

(52) U.S. Cl. CPC C08J 5/18; H01B 1/24; C08J 2363/00

(57) ABSTRACT

The present invention provides a graphene polymer conductive film and a method of manufacturing the graphene polymer conductive film. The method uses a graphene conductive polymer as conductive filler such that the drawbacks of the conventional conductive film such as exceeded filler content, expensive, complex manufacturing process and high environment pollution. The manufacture of graphene uses the method of in situ polymerization such that the conductive polymer and the graphene are distributed more uniformly, the produced graphene conductive polymer is with good stability, and the conductivity is proved. The present invention further realizes size control of the graphene conductive polymer in the process of manufacturing the graphene conductive polymer through adjusting the ratio of raw materials of the graphene and the conductive monomers. The graphene polymer conductive film produced by the present invention has advantages of high conductivity, environment friendly, etc., and could be applied in a thin film transistor liquid crystal display for substituting conductive golden film or conductive silver film, or applied in connecting superfine circuitry.

### FIELD OF THE INVENTION

The present invention relates to a technique field of liquid crystal display, and more particularly to a graphene polymer conductive film and method of manufacturing the same.

### BACKGROUND OF THE INVENTION

Conductive film is an important medium mainly comprised of conductive materials, resin substrate, dispersion agent, curing agent and accelerator. Nowadays, the ordinary filler used therein comprises silver and golden ball. Because the silver conductive film is expensive and the silver particle in the conductive film is easily oxidized, the silver particle is replaced by the golden ball gradually. However, the process of chemical electroplating method for manufacturing the conductive golden ball is very complex and the gold salts used in the procedure of gold electroplating are almost cyanides with great toxicity. Therefore, a new and cheap conductive filler is an important research nowadays.

Graphene is a carbon-nanomaterial having outstanding electrical and thermal conductivity. Once the graphene is used as the conductive filler in the conductive film, an outstanding conductivity can be provided for the conductive film. Besides, compared to a conductive channel formed by point contacting between the sphericity conductive particles, the probability of forming a conductive channel by surface contacting between the graphene since the graphene has a sheet structure. The outstanding thermal conductivity of the graphene ensures the heat dissipation of the conductive film by uniformly distributing the graphene sheet layer in the conductive film. By using the outstanding thermal conductivity, it is beneficial to dissipating the heat generated by Ohm effect of the current in the real application in time by the conductive film such that the temperature of the conductive film can be lowered and the conductive film is prevented from being failed.

Graphene itself has outstanding mechanical strength and ductility. Therefore, the sheet structure and the ductility of graphene ensure the stability of adhesion and conductivity even a large force is applied to the location of adhesion when the conductive film is used for adhering to an object. Graphene can further enhance the adhesive substrate and improves the adhesion strength of the conductive film.

A high performance conductive film is made in the patent of Chinese Patent No. CN102382606 by using graphene having special structure and good conductivity as the filler material. However, by using pure graphene as the conductive filler, the graphene sheet layers would be stacked and the benefit of high conductivity of the graphene could not be fully developed. Moreover, the conductivity of the graphene would be affected because the surface active agent used for improving distribution of the graphene in the conductive film changes the surface characteristic of the graphene. Besides, there exists the problem of exceeded filler content and higher cost.

Nowadays, the researches of using graphene as the conductive filler in the conductive film and other composite materials are widely reported.

The patent of Chinese Patent No. CN102643625 manufactures a conductive film by using particles covered by polyaniline as conductive filler and applies the conductive film in a liquid crystal display. The result shows that the particles covered by polyaniline conduct charges, maintain thickness effectively, and reduce cost effectively. However, the conductivity of conductive film made solely by using the polyaniline polymer as conductive filler is greatly poorer than the conductivity of the golden ball conductive film.

### SUMMARY OF THE INVENTION

An object of the present invention is to provide a method of manufacturing graphene polymer conductive film, which produces graphene conductive polymer composite material by performing in situ polymerization on raw materials of graphene and conductive monomers. The graphene conductive polymer composite material is used as conductive filler and is mixed with epoxy resin, curing agent and accelerator to produce a new graphene polymer conductive film such that the drawbacks of the conventional conductive film, such as expensive conductive filler, complex manufacturing process and high environment pollution, could be overcome.

Another object of the present invention is to provide a graphene polymer conductive film, which uses the graphene conductive polymer composite material as the conductive filler, such that restacking of graphene sheet layers could be overcome and the conductivity of the conductive film could be greatly improved. Furthermore, since the conductive filler has special structure and controllable size, the conductive film could be widely applied in superfine circuitry connection.

In order to achieve the above mentioned object, the present invention provides a method of manufacturing a graphene conductive film, which comprises:

step 1 for providing a powder of a graphene and a plurality of conductive monomers;

step 2 for providing a solvent and producing a graphene dispersion liquid by stirring and ultrasonic processing the solvent after mixing the powder of the graphene into the solvent;

step 3 for producing a mixed liquid having the graphene and the conductive monomers uniformly distributed by stirring and ultrasonic processing the graphene dispersion liquid after mixing the conductive monomers into the graphene dispersion liquid;

step 4 for mixing an initiator into the mixed liquid of the graphene and the conductive monomers such that an in situ polymerization of the conductive monomers is occurred on a surface of the graphene for producing a pre-liquid of a graphene conductive polymer composite material;

step 5 for producing a powder of the graphene conductive polymer composite material by removing solvent and impurity in the pre-liquid of the graphene conductive polymer composite material through a filtration process and a drying process;

step 6 for providing, mixing and stirring a certain proportion of an epoxy resin, a curing agent and an accelerator until the epoxy resin, the curing agent and the accelerator are uniformly distributed such that an epoxy resin glue system is produced;

step 7 for distributing the powder of the graphene conductive polymer composite material into the epoxy resin glue system to produce a pre-material of the graphene polymer conductive film; and

step 8 for deaerating the pre-material of the graphene polymer conductive film to produce the graphene polymer conductive film.

In the step 1, an amount of sheet of the powder of the graphene is less than 10, a size of the powder of the graphene is 1˜10 um, a conductivity of the powder of the graphene is greater than 1000 S/m, and the conductive monomers are aniline, pyrrole or thiophene.

When the conductive monomers in the step 1 are pyrrole, the initiator in the step 4 is ferric chloride, and a molar ratio of the ferric chloride and the pyrrole monomers is 2:1˜1:3.

When the conductive monomers in the step 1 are aniline or thiophene, the initiator in the step 4 is ammonium persulfate, and a molar ratio of the ammonium persulfate and the aniline or thiophene monomers is 1:1˜4:1.

In the step 2, the solvent is one or a mixture of some of water, ethanol, ethylene glycol, acetone, chloroform, N-methylpyrrolidone, tetrahydrofuran, dimethylformamide, or toluene; and a concentration of the graphene dispersion liquid is 0.01 mg/mL˜3 mg/mL.

In the step 3, a mass ratio of the graphene and the conductive monomers is 1:30˜10:1 in the mixed liquid of the graphene and the conductive monomers; and in the step 4, the in situ polymerization is occurred at −15˜5° C. for 1˜24 hour(s).

In the step 5, the filtration process is normal filtration or suction filtration, and the impurity in the pre-liquid of the graphene conductive polymer composite material is removed through alternating washing by ethanol and water in the filtration process; the drying process is freeze-drying or is drying at 20˜100° C.

In the step 6, the epoxy resin accounts for 80 wt %˜95 wt % of the epoxy resin glue system, the curing agent accounts for 1 wt %˜12 wt % of the epoxy resin glue system, and the accelerator accounts for 0.3 wt %˜5 wt % of the epoxy resin glue system; and the epoxy resin is bisphenol A type epoxy resin E44, bisphenol A type epoxy resin E51, bisphenol A type epoxy resin E54, bisphenol A type epoxy resin EPON826 or bisphenol A type epoxy resin EPON828; the curing agent is hexahydrophthalic anhydride, tetrahydrophthalic anhydride, succinic dihydrazide, adipodihydrazide, dicyandiamide or p-phenylenediamine; the accelerator is 2-ethyl-4-methylimidazole, imidazole, dimethylimidazole or triethylamine.

In the step 7, a mass ratio of the epoxy resin system and the graphene conductive polymer composite material is 100:2˜30.

The present invention further provides a graphene polymer conductive film manufactured by the method of manufacturing the graphene polymer conductive film.

The beneficial of the present invention is: the graphene polymer conductive film and the method of manufacturing the graphene polymer conductive film provided by the present invention uses a graphene conductive polymer as conductive filler such that the drawbacks of the conventional conductive film such as exceeded filler content, expensive, complex manufacturing process and high environment pollution. The manufacture of graphene uses the method of in situ polymerization such that the conductive polymer and the graphene are distributed more uniformly, the produced graphene conductive polymer is with good stability, and the conductivity is proved. The present invention further realizes size control of the graphene conductive polymer in the process of manufacturing the graphene conductive polymer through adjusting the ratio of raw materials of the graphene and the conductive monomers. The graphene polymer conductive film produced by the present invention has advantages of high conductivity, environment friendly, etc., and could be applied in a thin film transistor liquid crystal display for substituting conductive golden film or conductive silver film, or applied in connecting superfine circuitry. The graphene conductive polymer produced by the present invention could be made as conductive ink when distributed into some solvents such that it is commercially valuable in the field of soft circuitry.

In order to further understand the feature and technique content of the present invention, please refer the detailed description and drawings related to the present invention as below. The drawings are only for reference and explanation but not for limiting the present invention.

### BRIEF DESCRIPTION OF THE DRAWINGS

The technique solution and benefit effect of the present invention will become more readily apparent through the detailed description of the concrete embodiment of the present invention and accompanying drawings.

In the drawings:

FIG. 1 is a flow chart of the method of manufacturing the graphene polymer conductive film of the present invention.

FIG. 2 is a micro structure schematic diagram of the graphene conductive polymer composite material produced by the present invention.

FIG. 3 is a structural schematic diagram which shows applying the graphene polymer conductive film of the present invention on a thin film transistor liquid crystal display.

FIG. 4 is a structural schematic diagram which shows applying the graphene polymer conductive film of the present invention on a thin film transistor liquid crystal display.

FIG. 5 is a structural schematic diagram which shows applying the graphene polymer conductive film of the present invention on a thin film transistor liquid crystal display.

### DETAILED DESCRIPTION OF PREFERRED EMBODIMENTS

For further describing the technique solution and effect of the present invention, the detailed description of the preferred embodiment with the drawings of the present invention is made below.

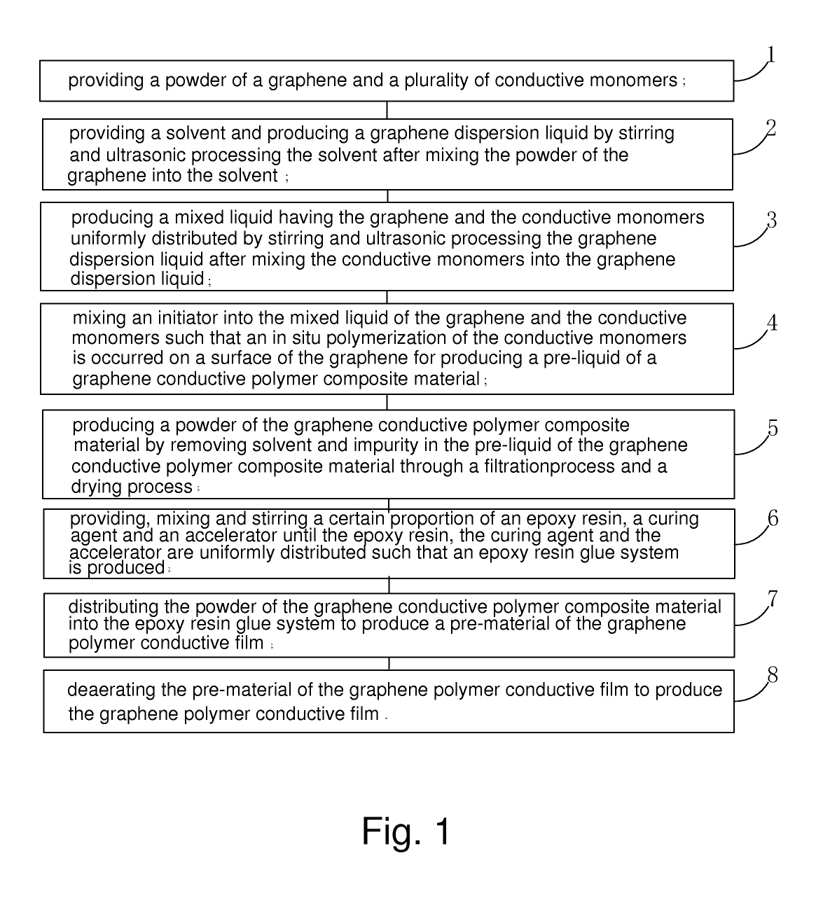

Please refer to FIG. 1, the present invention provides a method of manufacturing a graphene polymer conductive film, which comprises:

step 1 for providing a powder of a graphene and a plurality of conductive monomers;

step 2 for providing a solvent and producing a graphene dispersion liquid by stirring and ultrasonic processing the solvent after mixing the powder of the graphene into the solvent;

step 3 for producing a mixed liquid having the graphene and the conductive monomers uniformly distributed by stirring and ultrasonic processing the graphene dispersion liquid after mixing the conductive monomers into the graphene dispersion liquid;

step 4 for mixing an initiator into the mixed liquid of the graphene and the conductive monomers such that an in situ polymerization of the conductive monomers is occurred on a surface of the graphene for producing a pre-liquid of a graphene conductive polymer composite material;

step 5 for producing a powder of the graphene conductive polymer composite material by removing solvent and impurity in the pre-liquid of the graphene conductive polymer composite material through a filtration process and a drying process;

step 6 for providing, mixing and stirring a certain proportion of an epoxy resin, a curing agent and an accelerator until the epoxy resin, the curing agent and the accelerator are uniformly distributed such that an epoxy resin glue system is produced;

step 7 for distributing the powder of the graphene conductive polymer composite material into the epoxy resin glue system to produce a pre-material of the graphene polymer conductive film; and

step 8 for deaerating the pre-material of the graphene polymer conductive film to produce the graphene polymer conductive film.

In the step 1, an amount of sheet of the powder of the graphene is less than 10, a size of the powder of the graphene is 1˜10 um, a conductivity of the powder of the graphene is greater than 1000 S/m, and the conductive monomers are aniline, pyrrole or thiophene.

When the conductive monomers in the step 1 are pyrrole, the initiator in the step 4 is ferric chloride, and a molar ratio of the ferric chloride and the pyrrole monomers is 2:1˜1:3.

When the conductive monomers in the step 1 are aniline or thiophene, the initiator in the step 4 is ammonium persulfate, and a molar ratio of the ammonium persulfate and the aniline or thiophene monomers is 1:1˜4:1.

In the step 2, the solvent is one or a mixture of some of water, ethanol, ethylene glycol, acetone, chloroform, N-methylpyrrolidone, tetrahydrofuran, dimethylformamide, or toluene; and a concentration of the graphene dispersion liquid is 0.01 mg/mL˜3 mg/mL.

In the step 3, a mass ratio of the graphene and the conductive monomers is 1:30˜10:1 in the mixed liquid of the graphene and the conductive monomers; and

the size of the graphene conductive polymer can be controlled by adjusting the ratio of the graphene and the conductive monomers.

In the step 4, the in situ polymerization is occurred at −15˜5° C. for 1˜24 hour(s).

In the step 5, the filtration process is normal filtration or suction filtration, and the impurity in the pre-liquid of the graphene conductive polymer composite material is removed through alternating washing by ethanol and water in the filtration process; the drying process is freeze-drying or is drying at 20˜100° C.

In the step 6, the epoxy resin accounts for 80 wt %˜95 wt % of the epoxy resin glue system, the curing agent accounts for 1 wt %˜12 wt % of the epoxy resin glue system, and the accelerator accounts for 0.3 wt %˜5 wt % of the epoxy resin glue system; and

the epoxy resin is bisphenol A type epoxy resin E44, bisphenol A type epoxy resin E51, bisphenol A type epoxy resin E54, bisphenol A type epoxy resin EPON826 or bisphenol A type epoxy resin EPON828; the curing agent is hexahydrophthalic anhydride, tetrahydrophthalic anhydride, succinic dihydrazide, adipodihydrazide, dicyandiamide or p-phenylenediamine; the accelerator is 2-ethyl-4-methylimidazole, imidazole, dimethylimidazole or triethylamine.

In the step 7, a mass ratio of the epoxy resin system and the graphene conductive polymer composite material is 100:2˜30.

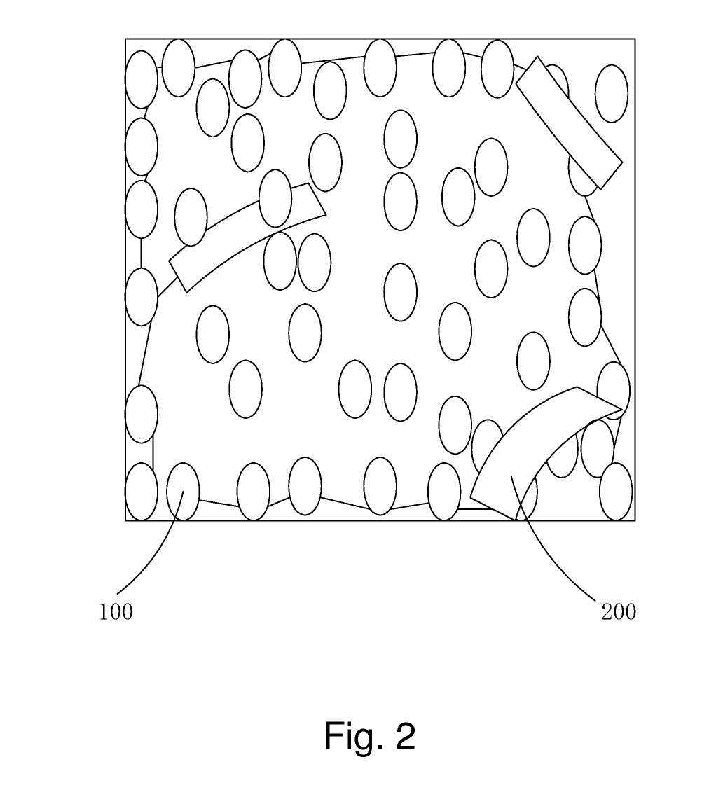

As shown in FIG. 2, the micro structure of the powder of the graphene conductive polymer composite material produced in the present invention is shown as: the conductive polymer 100 is distributed on the surface of the graphene 200 or is surrounded by the graphene 200, a certain amount of bonding forces are applied between the conductive polymer 100 and the graphene 200, and appears to be a three-dimensional network structure as a whole.

Besides applying in manufacturing conductive film, the graphene conductive polymer could be made as conductive ink when distributed into some solvents such that it is commercially valuable in the field of soft circuitry.

The method of manufacturing the graphene polymer conductive film of the present invention can be further described through the following three embodiments.

The method of manufacturing the graphene polymer conductive film according to the first embodiment of the present invention comprises the following steps:

Step 1: providing a powder of the graphene and a plurality of conductive monomers.

An amount of sheet of the powder of the graphene is less than 10, a size of the powder of the graphene is 1˜10 um, a conductivity of the powder of the graphene is greater than 1000 S/m. Aniline monomer is selected for the conductive monomers.

Step 2: distributing the powder of the graphene in a mixed solvent, in which the volume ratio of the ethanol and water is 1:1, and producing a graphene dispersion liquid, of which the concentration is 0.1 mg/mL, by stirring and ultrasonic processing the mixed solvent.

Step 3: producing a mixed liquid having the graphene and the aniline monomer uniformly distributed by stirring and ultrasonic processing the graphene dispersion liquid after mixing the aniline monomer into the graphene dispersion liquid. Preferably, the mass ratio of the graphene and the aniline monomer is 1:30.

Step 4: allocating an ammonium persulfate as an initiator, which is dissolved by HCL having a concentration of 1 mol/L, dripping the ammonium persulfate dissolved by HCL dropwise into the mixed liquid of the graphene and the aniline at −15° C., and stirring for 24 hours such that an in situ polymerization of the aniline monomers is occurred on the surface of the graphene for producing a pre-liquid of a graphene polyaniline composite material. Preferably, the mole ratio of the ammonium persulfate and the aniline monomers is 1:1.

Step 5: performing suction filtration on the pre-liquid of the graphene polyaniline composite material by microporous membrane, of which the pore size is 0.2 um; washing three times during the suction filtration in total of 90 mL ethanol and 500 mL deionized water, respectively, wherein the ethanol and deionized water is alternately applied for washing, and a filter cake is obtained after washing; removing the filter cake from the microporous membrane, putting the filter cake into a small beaker and adding adequate water to submerge the filter cake; freezing the filter cake in a freeze drying box for 12 hours after freezing the filter cake under 0° C., and obtaining a powder of the graphene polyaniline composite material therefrom.

Step 6: weighting the mass of each composition as follows: bisphenol A type epoxy resin E44 (93%), hexahydrophthalic anhydride (6%), and 2-ethyl-4-methylimidazole (1%); mixing and stirring until the compositions are uniformly distributed to produce an epoxy resin glue system.

Step 7: mixing the powder of the graphene polyaniline composite material with the epoxy resin glue system. Preferably, the mass ratio of the epoxy resin glue system and the powder of the graphene polyaniline composite material is 10:1. The powder of the graphene polyaniline composite material and the epoxy resin glue system are mixed and stirred until being uniformly distributed so as to produce the pre-material of the graphene polyaniline conductive film.

Step 8: putting the produced pre-material of the graphene polyaniline conductive film into a deaerator, and deaerating the pre-material of the graphene polyaniline conductive film under the situation of a vacuum degree of 0.7 KPa and a rotation speed of 500 rpm for 30 minutes so as to produce the graphene polyaniline conductive film.

The method of manufacturing the graphene polymer conductive film according to the second embodiment of the present invention comprises the following steps:

Step 1: providing a powder of the graphene and a plurality of conductive monomers.

An amount of sheet of the powder of the graphene is less than 10, a size of the powder of the graphene is 1˜10 um, a conductivity of the powder of the graphene is greater than 1000 S/m. Pyrrole monomer is selected for the conductive monomers.

Step 2: distributing the powder of the graphene in isopropanol, and producing a graphene dispersion liquid, of which the concentration is 0.1 mg/mL, by stirring and ultrasonic processing the mixed solvent.

Step 3: producing a mixed liquid having the graphene and the pyrrole monomer uniformly distributed by stirring and ultrasonic processing the graphene dispersion liquid after mixing the pyrrole monomer into the graphene dispersion liquid. Preferably, the mass ratio of the graphene and the pyrrole monomer is 1:1.

Step 4: allocating an ferric chloride alcohol solution having a concentration of 0.4 mol/L as an initiator, dripping the ferric chloride alcohol solution dropwise into the mixed liquid of the graphene and the pyrrole at −10° C., and stirring for 24 hours such that an in situ polymerization of the pyrrole monomers is occurred on the surface of the graphene for producing a pre-liquid of a graphene polypyrrole composite material. Preferably, the mole ratio of the ferric chloride and the pyrrole monomers is 2:1.

Step 5: performing suction filtration on the pre-liquid of the graphene polypyrrole composite material by microporous membrane, of which the pore size is 0.2 um; washing three times during the suction filtration in total of 90 mL ethanol and 500 mL deionized water, respectively, wherein the ethanol and deionized water is alternately applied for washing, and a filter cake is obtained after washing; removing the filter cake from the microporous membrane and putting the filter cake into a vacuum drying box to dry the filter cake at 100° C. for 12 hours so as to produce the graphene polypyrrole composite material.

Step 6: weighting the mass of each composition as follows: bisphenol A type epoxy resin E51 (91%), tetrahydrophthalic anhydride (7%), and dimethylimidazole (2%); mixing and stirring until the compositions are uniformly distributed so as to produce an epoxy resin glue system.

Step 7: mixing the graphene polypyrrole composite material with the epoxy resin glue system. Preferably, the mass ratio of the epoxy resin glue system and the graphene polypyrrole composite material is 12:1. The graphene polypyrrole composite material and the epoxy resin glue system are mixed and stirred until being uniformly distributed so as to produce the pre-material of the graphene polypyrrole conductive film.

Step 8: putting the produced pre-material of the graphene polypyrrole conductive film into a deaerator, and deaerating the pre-material of the graphene polypyrrole conductive film under the situation of a vacuum degree of 0.7 KPa and a rotation speed of 500 rpm for 30 minutes so as to produce the graphene polypyrrole conductive film.

The method of manufacturing the graphene polymer conductive film according to the third embodiment of the present invention comprises the following steps:

Step 1: providing a powder of the graphene and a plurality of conductive monomers.

An amount of sheet of the powder of the graphene is less than 10, a size of the powder of the graphene is 1˜10 um, a conductivity of the powder of the graphene is greater than 1000 S/m. Thiophene monomer is selected for the conductive monomers.

Step 2: distributing the powder of the graphene in N-methylpyrrolidone (NMP), and producing a graphene dispersion liquid, of which the concentration is 0.1 mg/mL, by stirring and ultrasonic processing the mixed solvent.

Step 3: producing a mixed liquid having the graphene and the thiophene monomer uniformly distributed by stirring and ultrasonic processing the graphene dispersion liquid after mixing the thiophene monomer into the graphene dispersion liquid. Preferably, the mass ratio of the graphene and the thiophene monomer is 10:1.

Step 4: allocating an ammonium persulfate as an initiator, which is dissolved by HCL having a concentration of 1 mol/L, dripping the ammonium persulfate dissolved by HCL dropwise into the mixed liquid of the graphene and the thiophene at 0° C., and stirring for 24 hours such that an in situ polymerization of the thiophene monomers is occurred on the surface of the graphene for producing a pre-liquid of a graphene polythiophene composite material. Preferably, the mole ratio of the ammonium persulfate and the thiophene monomers is 3:1.

Step 5: performing suction filtration on the pre-liquid of the graphene polythiophene composite material by microporous membrane, of which the pore size is 0.2 um; washing three times during the suction filtration in total of 90 mL ethanol and 500 mL deionized water, respectively, wherein the ethanol and deionized water is alternately applied for washing, and a filter cake is obtained after washing; removing the filter cake from the microporous membrane and putting the filter cake into a vacuum drying box to dry the filter cake at 80° C. for 12 hours so as to produce the graphene polythiophene composite material.

Step 6: weighting the mass of each composition as follows: bisphenol A type epoxy resin EPON826 (88%), hexahydrophthalic anhydride (9%), and triethylamine (3%); mixing and stirring until the compositions are uniformly distributed so as to produce an epoxy resin glue system.

Step 7: mixing the graphene polythiophene composite material with the epoxy resin glue system. Preferably, the mass ratio of the epoxy resin glue system and the graphene polythiophene composite material is 8:1. The graphene polythiophene composite material and the epoxy resin glue system are mixed and stirred until being uniformly distributed so as to produce the pre-material of the graphene polythiophene conductive film.

Step 8: putting the produced pre-material of the graphene polythiophene conductive film into a deaerator, and deaerating the pre-material of the graphene polythiophene conductive film under the situation of a vacuum degree of 0.7 KPa and a rotation speed of 500 rpm for 30 minutes so as to produce the graphene polythiophene conductive film.

The embodiments described above are just a few examples of the present invention. Similar graphene polymer conductive film can be obtained through variations and transformations on conditions, such as ratio and composition, of the present invention. These variations and transformations, while being within the idea of the present invention, are in the protection scope requested by the claims attached in the present application.

The graphene polymer conductive film produced by the present invention could be applied in a thin film transistor liquid crystal display for substituting conductive golden film or conductive silver film. The graphene polymer conductive film could also be widely applied in superfine circuitry connection.

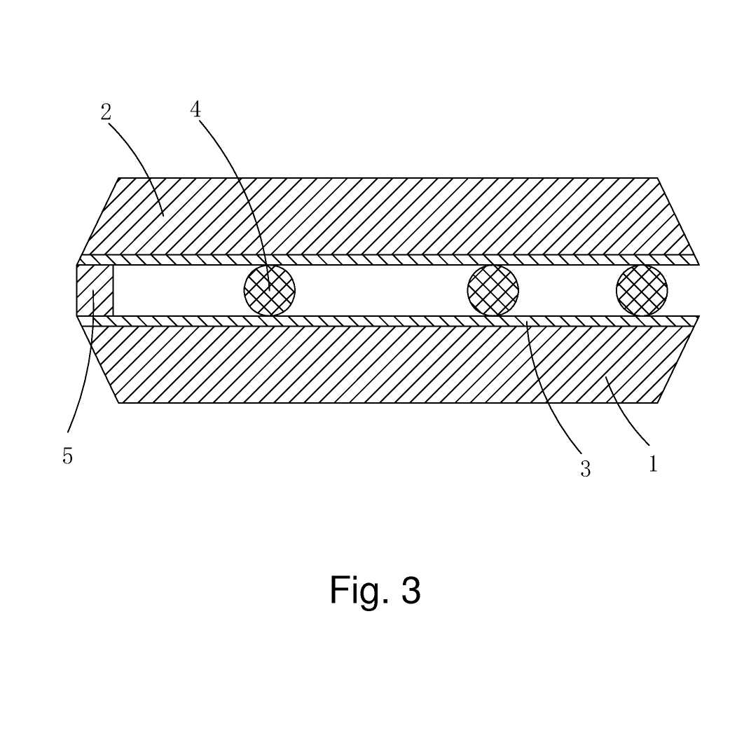

As shown in FIG. 3, the graphene polymer conductive film produced by the present invention could be applied in a thin film transistor liquid crystal display for substituting conductive golden film or conductive silver film. An ITO electrode 3 is formed on the inner surface of the TFT (Thin Film Transistor) and the inner surface of the CF (Color Filter) substrate 2 opposite to the TFT substrate 1. TFT substrate 1 and the CF substrate 2 are jointed together through a frame glue 5. The graphene polymer conductive film 4 is applied between the TFT substrate 1 and the CF substrate 2 so as to substitute the conductive golden film or the conductive silver film.

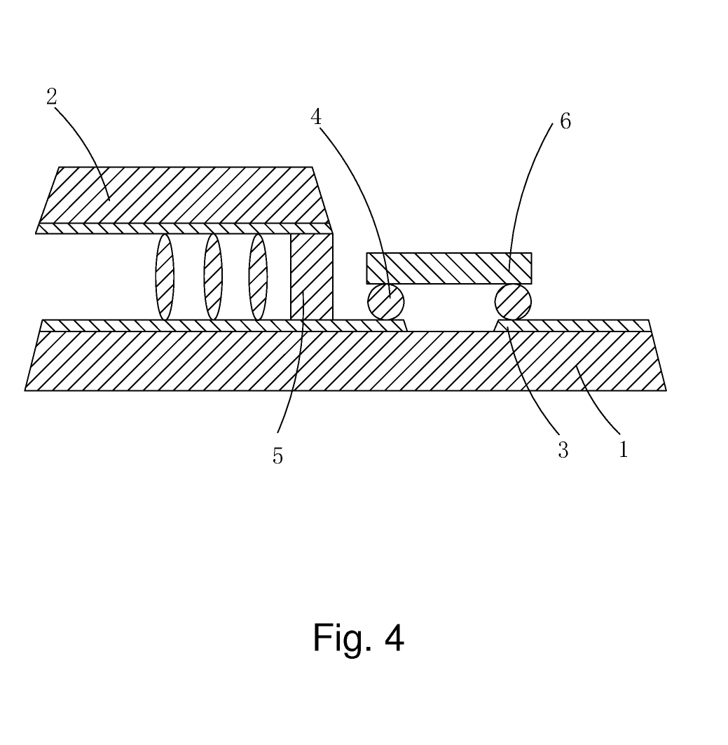

As shown in FIG. 4, the graphene polymer conductive film produced by the present invention could be applied in a thin film transistor liquid crystal display for realizing connection of superfine circuitry. An ITO electrode 3 is formed on the inner surface of the TFT (Thin Film Transistor) substrate 1 and the inner surface of the CF (Color Filter) substrate 2 opposite to the TFT substrate 1. TFT substrate 1 and the CF substrate 2 are jointed together through a frame glue 5. IC (Integrated circuit) chip 6 and ITO (Indium tin oxide) electrode 3 are connected through the graphene polymer conductive film 4.

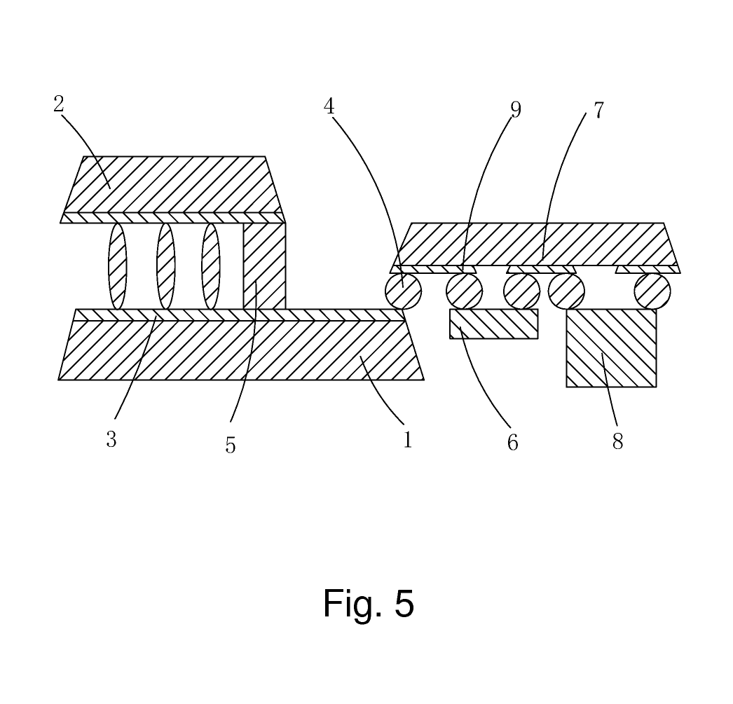

As shown in FIG. 5, the graphene polymer conductive film produced by the present invention could be applied in a thin film transistor liquid crystal display for realizing connection of superfine circuitry. An ITO electrode 3 is formed on the inner surface of the TFT (Thin Film Transistor) substrate 1 and the inner surface of the CF (Color Filter) substrate 2 opposite to the TFT substrate 1. TFT substrate 1 and the CF substrate 2 are jointed together through a frame glue 5. By directly carrying the IC chip 6 and electronic element 8 on the copper foil 9 of the flexible printed circuit board 7 through the graphene polymer conductive film 4, connection between the IC chip 6 and the ITO electrode 3 can be realized.

In summary, the graphene polymer conductive film and the method of manufacturing the graphene polymer conductive film provided by the present invention uses graphene conductive polymers as conductive filler such that the drawbacks of the conventional conductive film such as exceeded filler content, expensive, complex manufacturing process and high environment pollution. The manufacture of graphene uses the method of in situ polymerization such that the conductive polymer and the graphene are distributed more uniformly, the produced graphene conductive polymer is with good stability, and the conductivity is proved. The present invention further realizes size control of the graphene conductive polymer in the process of manufacturing the graphene conductive polymer through adjusting the ratio of raw materials of the graphene and the conductive monomers. The graphene polymer conductive film produced by the present invention has advantages of high conductivity, environment friendly, etc., and could be applied in a thin film transistor liquid crystal display for substituting conductive golden film or conductive silver film, or applied in connecting superfine circuitry. The graphene conductive polymer produced by the present invention could be made as conductive ink when distributed into some solvents such that it is commercially valuable in the field of soft circuitry.

What is claimed is:

1. A method of manufacturing a graphene polymer conductive film, comprising:
step 1 for providing a powder of a graphene and a plurality of conductive monomers;
step 2 for providing a solvent and producing a graphene dispersion liquid by stirring and ultrasonic processing the solvent after mixing the powder of the graphene into the solvent;
step 3 for producing a mixed liquid having the graphene and the conductive monomers uniformly distributed by stirring and ultrasonic processing the graphene dispersion liquid after mixing the conductive monomers into the graphene dispersion liquid;
step 4 for mixing an initiator into the mixed liquid of the graphene and the conductive monomers such that an in situ polymerization of the conductive monomers is occurred on a surface of the graphene for producing a pre-liquid of a graphene conductive polymer composite material;
step 5 for producing a powder of the graphene conductive polymer composite material by removing solvent and impurity in the pre-liquid of the graphene conductive polymer composite material through a filtration process and a drying process;
step 6 for providing, mixing and stirring a certain proportion of an epoxy resin, a curing agent and an accelerator until the epoxy resin, the curing agent and the accelerator are uniformly distributed such that an epoxy resin glue system is produced;
step 7 for distributing the powder of the graphene conductive polymer composite material into the epoxy resin glue system to produce a pre-material of the graphene polymer conductive film; and
step 8 for deaerating the pre-material of the graphene polymer conductive film to produce the graphene polymer conductive film.

2. The method of manufacturing the graphene polymer conductive film according to claim 1, wherein in the step 1, an amount of sheet of the powder of the graphene is less than 10, a size of the powder of the graphene is 1˜10 um, a conductivity of the powder of the graphene is greater than 1000 S/m, and the conductive monomers are aniline, pyrrole or thiophene.

3. The method of manufacturing the graphene polymer conductive film according to claim 2, wherein when the conductive monomers in the step 1 are pyrrole, the initiator in the step 4 is ferric chloride, and a molar ratio of the ferric chloride and the pyrrole monomers is 2:1˜1:3.

4. The method of manufacturing the graphene polymer conductive film according to claim 2, wherein when the conductive monomers in the step 1 are aniline or thiophene, the initiator in the step 4 is ammonium persulfate, and a molar ratio of the ammonium persulfate and the aniline or thiophene monomers is 1:1˜4:1.

5. The method of manufacturing the graphene polymer conductive film according to claim 1, wherein in the step 2, the solvent is one or a mixture of some of water, ethanol, ethylene glycol, acetone, chloroform, N-methylpyrrolidone, tetrahydrofuran, dimethylformamide, or toluene; and a concentration of the graphene dispersion liquid is 0.01 mg/mL˜3 mg/mL.

6. The method of manufacturing the graphene polymer conductive film according to claim 1, wherein in the step 3, a mass ratio of the graphene and the conductive monomers is 1:30˜10:1 in the mixed liquid of the graphene and the conductive monomers;
in the step 4, the in situ polymerization is occurred at −15˜5° C. for 1˜24 hour(s).

7. The method of manufacturing the graphene polymer conductive film according to claim 1, wherein in the step 5, the filtration process is normal filtration or suction filtration, and the impurity in the pre-liquid of the graphene conductive polymer composite material is removed through alternating washing by ethanol and water in the filtration process; the drying process is freeze-drying or is drying at 20˜100° C.

8. The method of manufacturing the graphene polymer conductive film according to claim 1, wherein in the step 6, the epoxy resin accounts for 80 wt %˜95 wt % of the epoxy resin glue system, the curing agent accounts for 1 wt %˜12 wt % of the epoxy resin glue system, and the accelerator accounts for 0.3 wt %˜5 wt % of the epoxy resin glue system;
the epoxy resin is bisphenol A type epoxy resin E44, bisphenol A type epoxy resin E51, bisphenol A type epoxy resin E54, bisphenol A type epoxy resin EPON826 or bisphenol A type epoxy resin EPON828; the curing agent is hexahydrophthalic anhydride, tetrahydrophthalic anhydride, succinic dihydrazide, adipodihydrazide, dicyandiamide or p-phenylenediamine; the accelerator is 2-ethyl-4-methylimidazole, imidazole, dimethylimidazole or triethylamine.

9. The method of manufacturing the graphene polymer conductive film according to claim 1, wherein in the step 7, a mass ratio of the epoxy resin system and the graphene conductive polymer composite material is 100:2˜30.

10. A graphene polymer conductive film manufactured by the method of manufacturing the graphene polymer conductive film according to claim 1.

11. A method of manufacturing a graphene polymer conductive film, comprising:
step 1 for providing a powder of a graphene and a plurality of conductive monomers;
step 2 for providing a solvent and producing a graphene dispersion liquid by stirring and ultrasonic processing the solvent after mixing the powder of the graphene into the solvent;
step 3 for producing a mixed liquid having the graphene and the conductive monomers uniformly distributed by stirring and ultrasonic processing the graphene dispersion liquid after mixing the conductive monomers into the graphene dispersion liquid;
step 4 for mixing an initiator into the mixed liquid of the graphene and the conductive monomers such that an in situ polymerization of the conductive monomers is occurred on a surface of the graphene for producing a pre-liquid of a graphene conductive polymer composite material;
step 5 for producing a powder of the graphene conductive polymer composite material by removing solvent and impurity in the pre-liquid of the graphene conductive polymer composite material through a filtration process and a drying process;
step 6 for providing, mixing and stirring a certain proportion of an epoxy resin, a curing agent and an accelerator until the epoxy resin, the curing agent and the accelerator are uniformly distributed such that an epoxy resin glue system is produced;
step 7 for distributing the powder of the graphene conductive polymer composite material into the epoxy resin glue system to produce a pre-material of the graphene polymer conductive film; and
step 8 for deaerating the pre-material of the graphene polymer conductive film to produce the graphene polymer conductive film;
wherein in the step 1, an amount of sheet of the powder of the graphene is less than 10, a size of the powder of the graphene is 1˜10 um, a conductivity of the powder of the graphene is greater than 1000 S/m, and the conductive monomers are aniline, pyrrole or thiophene;
wherein when the conductive monomers in the step 1 are pyrrole, the initiator in the step 4 is ferric chloride, and a molar ratio of the ferric chloride and the pyrrole monomers is 2:1˜1:3;
wherein when the conductive monomers in the step 1 are aniline or thiophene, the initiator in the step 4 is ammonium persulfate, and a molar ratio of the ammonium persulfate and the aniline or thiophene monomers is 1:1˜4:1;
wherein in the step 2, the solvent is one or a mixture of some of water, ethanol, ethylene glycol, acetone, chloroform, N-methylpyrrolidone, tetrahydrofuran, dimethylformamide, or toluene; and a concentration of the graphene dispersion liquid is 0.01 mg/mL˜3 mg/m;
wherein in the step 3, a mass ratio of the graphene and the conductive monomers is 1:30˜10:1 in the mixed liquid of the graphene and the conductive monomers; in the step 4, the in situ polymerization is occurred at −15˜5° C. for 1˜24 hour(s);
wherein in the step 5, the filtration process is normal filtration or suction filtration, and the impurity in the pre-liquid of the graphene conductive polymer composite material is removed through alternating washing by ethanol and water in the filtration process; the drying process is freeze-drying or is drying at 20˜100° C.;
wherein in the step 6, the epoxy resin accounts for 80 wt %˜95 wt % of the epoxy resin glue system, the curing agent accounts for 1 wt %˜12 wt % of the epoxy resin glue system, and the accelerator accounts for 0.3 wt %˜5 wt % of the epoxy resin glue system; the epoxy resin is bisphenol A type epoxy resin E44, bisphenol A type epoxy resin E51, bisphenol A type epoxy resin E54, bisphenol A type epoxy resin EPON826 or bisphenol A type epoxy resin EPON828; the curing agent is hexahydrophthalic anhydride, tetrahydrophthalic anhydride, succinic dihydrazide, adipodihydrazide, dicyandiamide or p-phenylenediamine; the accelerator is 2-ethyl-4-methylimidazole, imidazole, dimethylimidazole or triethylamine;
wherein in the step 7, the mass ratio of the epoxy resin system and the graphene conductive polymer composite material is 100:2˜30.
